(19) United States
(12) Patent Application Publication
(10) Pub. No.: US 2003/0122679 A1
(43) Pub. Date: Jul. 3, 2003

(54) Production system wherein fabrication data are collected using light tower control signals

(75) Inventors: Iwao Matsushima, Shiga (JP); Junichi Tanaka, Shiga (JP); Tokuhiro Uchiyama, Shiga (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/026,430

(22) Filed: Dec. 27, 2001

(30) Foreign Application Priority Data
Dec. 28, 2000 (JP) 2000-400834
Mar. 8, 2001 (JP) 2001-064953
Mar. 8, 2001 (JP) 2001-064954
Mar. 30, 2001 (JP) 2001-098022

(51) Int. Cl. G08B 21/00

(52) U.S. Cl. 340/635; 340/634

(57) ABSTRACT

A production system comprises a plurality of fabrication apparatuses arranged in series for performing a sequential processing of work units applied to the system. All or some of the fabrication apparatuses are respectively equipped with sets of lamps each of which visually indicates fabrication states of the corresponding fabrication apparatus by energizing or de-energizing different colored lamps. A lamp control signal monitor is provided in each fabrication apparatus having the set of lamps. The lamp control signal monitor receives lamp control information used to energize or de-energize the colored lamps, and stores therein data indicative of start and finish time points and time durations of energization and de-energization of the colored lamps.

### BACKGROUND OF THE INVENTION

1. Field of the Invention

The present invention relates generally to a production system which comprises a plurality of fabrication apparatuses arranged in series to successively process or assemble work units. More specifically, the present invention relates to such a production system wherein light towers for visibly indicating processing states are provided to the fabrication apparatuses. Still more specifically, the present invention relates to such a system wherein the fabrication data are gathered using light tower control signals.

2. Description of Related Art

Prior to turning to the present invention it is deemed advantageous to briefly describe, with reference to FIG. 1, one example of conventional production system (depicted by 10) that is relevant to the present invention.

As shown in FIG. 1, the production system 10 is comprised of a plurality of fabrication apparatuses 12a-12n sequentially arranged so as to successively process or assemble work units applied from corresponding upstream apparatuses. More specifically, raw word units (e.g., electronic components) are supplied to the first fabrication apparatus 12a whose outputs are then supplied to the following apparatus 12b, and these operations are repeated at the following apparatuses and finally the finished work units are obtained at the final fabrication apparatus 12n.

Although not shown in FIG. 1, one or more of the fabrication apparatuses 12b-12n (viz., except for the leading one 12a) may be supplied with new work units in addition to the outputs of the corresponding preceding apparatus. Further, it may be typical to provide a workstation between the adjacent fabrication apparatuses in order to receive the outputs of the preceding apparatus and supply the same to the following one with or without adding adequate values. Since the fabrication apparatuses work independently with each another, the production system 10 is suited for mass production of identical or similar work units.

It is not seldom in practice that some of the fabrication apparatuses 12 are replaced with up-to-date ones over a period, or new apparatuses are added to meet the changes of model, specifications, etc. of the products. As a result, the production system 10 may involve a variety of fabrication apparatuses which differ in terms of mechanism, control systems, production efficiencies, etc. By way of example, some fabrication apparatuses operate under the control of old-style electromagnetic relay sequencers, others are controlled by old-fashioned microcomputers, and others are equipped with the latest microcomputers. In other words, a variety of controllers are mixed in a usual production system, and as such, it is extremely difficult to collect identical process data therefrom for production analysis without large-scale and thus costly modifications of the fabrication apparatus control systems.

Japanese Laid-open Patent Application No. 5-138511 discloses a production control system wherein various pieces of process information are derived from each control system of production apparatuses, which data are then displayed in arbitrary formats. However, this prior art has encountered thee difficulties that it is unable to obtain data from the different kinds of control systems unless the data format are identical with each other. Accordingly, the prior art is not applicable to the production system wherein different kinds of control systems are utilized.

### SUMMARY OF THE INVENTION

It is therefore an object of the present invention to provide a production system wherein process data can effectively be collected from plural fabrication apparatuses having different control systems without substantial change of the apparatus.

Another object of the present invention is to provide a production system wherein fabrication data are gathered using light tower control signals used to control a light tower which visibly indicates different process states of the apparatus.

In brief, these objects are achieved by the techniques wherein a production system comprises a plurality of fabrication apparatuses arranged in series for performing a sequential processing of work units applied to the system. All or some of the fabrication apparatuses are respectively equipped with light towers each of which visually indicates fabrication states of the corresponding fabrication apparatus by energizing or de-energizing different colored lamps. A lamp control signal monitor is provided in each fabrication apparatus having the light tower. The lamp control signal monitor receives lamp control information used to energize or de-energize the colored lamps, and stores the data indicative of start and finish time points and time durations of energization and de-energization of the colored lamps.

### BRIEF DESCRIPTION OF THE DRAWINGS

The features and advantages of the present invention will become more clearly appreciated from the following description taken in conjunction with the accompanying drawings in which like elements or portions are denoted by like reference numerals and in which:

FIG. 1 is a diagram schematically showing prior art of a production system comprising a plurality of fabrication apparatuses arranged in series, having referred to in be opening paragraphs;

FIG. 2A shows an appearance of a fabrication apparatus with a light tower and a display, which is presented for briefly describing embodiments of the present invention;

FIG. 2B is a diagram schematically showing a variation of the location of the display of FIG. 2A;

FIG. 3 is a diagram schematically showing a light tower controller, a lamp control signal monitor, etc. wherein the monitor is directly relevant to the present invention;

FIG. 4 is a block diagram schematically showing a first embodiment of the present invention;

FIGS. 5 is a block diagram schematically showing a second embodiment of the present invention;

FIG. 6 is a block diagram schematically showing a third embodiment of the present invention;

FIG. 7 is a block diagram schematically showing a fourth embodiment of the present invention;

FIG. 8 is a block diagram schematically showing a fifth embodiment of the present invention;

FIG. 9 is a block diagram schematically showing a sixth embodiment of the present invention; and

FIG. 10 is a block diagram schematically showing a seventh embodiment of the present invention.

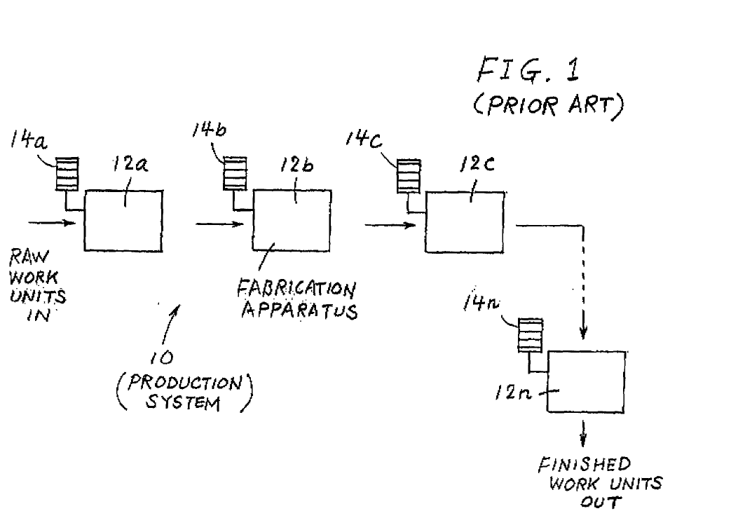

### DETAILED DESCRIPTION OF THE PREFERRED EMBODIMENTS

As referred to in the opening paragraphs, it is a common practice to provide each of the fabrication apparatuses with the option (viz., light tower) to visually indicate the states of the fabrication processes. The light tower is typically equipped with white, red, yellow, and blue lamps so as to issue visible indications of different states of the production processes.

A principle underlying the present invention is to use light tower control signals for collecting production data from fabrication apparatuses which are a mixture of different types in terms of production date, control systems, data format typos, etc. In other words, the present invention takes advantage of the fact that the lamp control signals, which are used for on-and-off operations of the lamps, are typically identical irrespective of different types or models of the fabrication apparatuses.

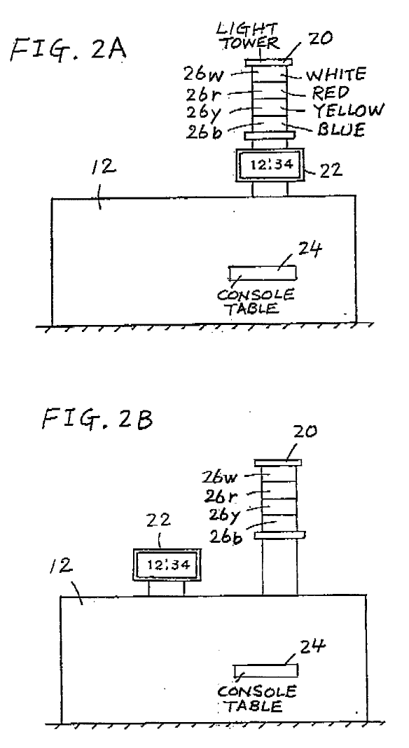

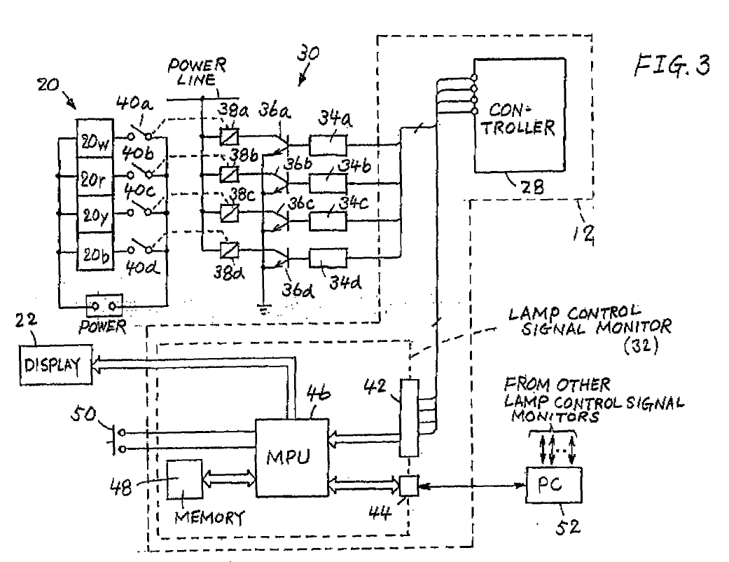

A first embodiment of the present invention will be described with reference to FIGS. 2A, 2B, 3, and 4. It is to be noted that the arrangements of FIGS. 2A, 2B and 3 are also applicable to the remaining embodiments of the present invention.

FIG. 2A is a diagram schematically showing an appearance of a fabrication apparatus 12, a light tower 20, and a display 22. As shown in FIG. 2A, the light tower 20 is mounted on the fabrication apparatus 12, and the display 22 is attached to the tower 20 so as to readily be viewed by operators, and typically takes the form of an LCD (liquid crystal display). As an alternative, as shown in FIG. 2B, the display 22 can be located directly on the fabrication apparatus 12. The fabrication apparatus 12 is further provided with a console table 24 oh which there are provided a keyboard, suitable control buttons (neither shown) for inputting or setting a variety of fabrication instructions.

As shown in FIG. 2A or 2B, white, red, yellow, and blue lamps (respectively denoted by 26w, 26r, 26yand 26b) are provided on the light tower 20. When the fabrication apparatus 12 is in shutdown or idle period, all the lamps are de-energized (i.e., turned off). A blue lamp 26b is energized (i.e., turned on) to indicate that the fabrication apparatus 12 is in an automatic operation mode. To indicate that the apparatus 12 requires a supply of work units (pieces), the apparatus energizes the yellow tamp 26y. An alarm is indicated by energizing the red lamp 26r, and to indicate that the apparatus is a repair mode or in a preventative maintenance mode, the while lamp 26w is energized. Further, to indicate that the amount of the work units waiting for supply to the apparatus 12 becomes small, the yellow lamp 26y is flashed. The above-mentioned indications by energizing or de-energizing lamps are exemplary, and it is understood that other states of the fabrication apparatus 12 can be indicated by, for example, flashing the white, red, blue lamps, which however is not directly concerned with the present invention and thus the descriptions thereof will be omitted for brevity.

FIG. 3 is a diagram schematically showing a controller 28 and a lamp control signal monitor 32 both of which are included in the fabrication apparatus 12, a tower lamp control circuit 30, a personal computer (PC) 52, together with the light tower 20 and the display 22. The lamp control signal monitor 32 is directly concerned with the present invention. The fabrication apparatus 12 is provided with fabrication mechanism which is however not shown in that the present invention is irrelevant thereto.

The circuit 30 comprises lamp control units 34a-34d to which lamp control signals are applied from the controller 28, and which units are respectively assigned to the lamps 20w, 20r, 20y and 20b. The lamp control units 34a-34d analyze the lamp control signals applied thereto and drive switch controllers 36a-36d (viz., transistors in this case) respectively. The switch controllers 36a-36d are respectively followed by electromagnetic switch coils 38a-38d for controlling on and off operations of corresponding switch contacts (denoted by 4Oa-40d).

By way of example, when the transistor 36a is closed in response to the output of the lamp control unit 34a, a current flows through the coil 38a so as to close the switch contact 40a whereby the white lamp 20w is energized. It is understood that the lamp control signals issued from the controller 28 is quite simple because they merely indicate on-and-off operations of the lamps, and accordingly further descriptions thereof will be omitted for the sake of simplifying the disclosure.

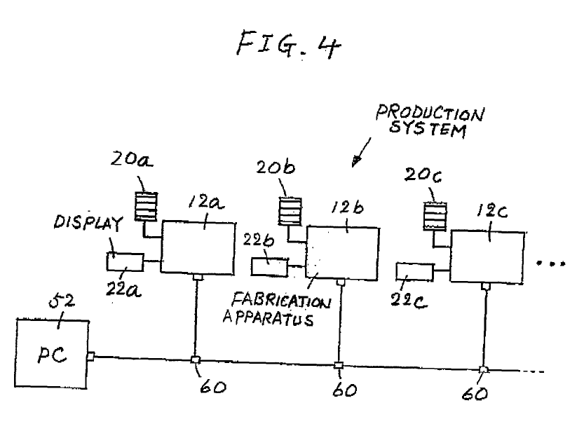

The lamp control signals, outputted from the controller 28, are also applied to the lamp control signal monitor 32, which comprises a parallel interface 42, a serial interface 44, a microprocessor unit (MPU) 46, and a memory 48. The lamp control signal monitor 32 is operatively coupled to the display 22, a display control switch 50, and the personal computer 52. The computer 52 serves to load suitable software to the CPU 46, and applies date-and-time information to the MPU 46, and collecting the data stored in the memory 48. Further, the computer 52 is coupled to a plurality of lamp control signal monitors of the other fabrication apparatuses (not shown in FIG. 3 but best shown in FIG. 4).

The MPU 46 is supplied, via the parallel interface 42, with the lamp control signals from the controller 28, determining the time duration of energizing and de-energizing each of the lamps 20w, 20r, 20y, and 20b, the start and finish time points of the time duration, and storing such pieces of information (viz., data) in the memory 48. The display control switch 50, which is operatively coupled to the MPU 46, is used to display the pieces of information stored in the memory 48 on the display 22 one by one in order settled beforehand every time the switch 50 is closed. Further, it is possible to display, on the display 22, two or more pieces of information such as two or more time durations at the same time or one time duration together with the start and finish time points thereof. The lamp control data thus obtained are applied to the personal computer 52 and used to analyze the operation of the apparatus 12. The data analysis per se is irrelevant to the present invention, and as such, the details thereof are deemed redundant and will be omitted for brevity.

Reference is made to FIG. 4, a plurality of fabrication apparatuses 12a, 12b, 12c, . . . are coupled to the personal computer 52 (see FIG. 3) using appropriate interfaces (not shown) and connectors 60. The connection of the lamp control signal monitors (one example is shown in FIG. 3) to the computer 52 can be implemented using well-known techniques. The operation data of the production system comprising a plurality of fabrication apparatus 12a, 12b, 12c, . . . are gathered and then analyzed using suitable software in terms of the start and finish time points and time duration with respect to automatic operation, work piece waiting, maintenance, repair, issuance of alarm, breakdown, etc. Based on data, it is possible to obtain a variety of production managing data for use in control of labor costs, equipment maintenance, production scheduling, etc.

The data stored in the computer 52 should be discriminated to indicate which fabrication apparatus issued the data. To this end, the fabrication apparatus attaches the information indicative of the data origin at the time when initially storing the data. As an alternative, it is possible to attach such information to the data when the computer 52 acquires the data from each of the fabrication apparatuses. The attachment of the abovementioned information is necessary for each of the remaining embodiments of the present invention.

In the above, the fabrication apparatuses 12a, 12b, 12c, . . . are all provided with the light towers 14, but the present invention is not restricted thereto. That is to say, the present invention is applicable to the case where some of the fabrication apparatuses lack the light towers. Even if the process data can not be obtained from every fabrication apparatuses due to the absence of light towers, the overall operation analysis of the system can well be estimated.

It is preferable to provide a power source (not shown) dedicated to the lamp control signal monitor 32 in order that an operator is able to display the data stored in the memory 48 while the fabrication apparatus 12 is in shutdown (viz., de-energized).

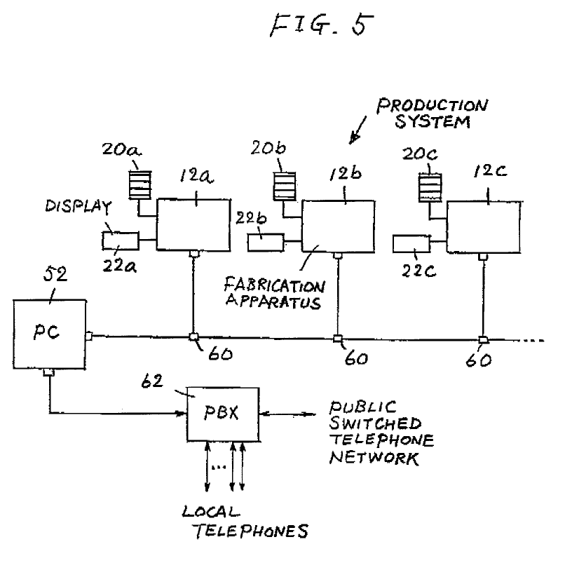

Referring to FIG. 5, a second embodiment of the present invention is schematically shown in block diagram form. According to the instant embodiment, the data stored in the personal computer 52 can be accessed by both local and distant telephones via a private branch exchange (PBX) 62. Other than this, the second embodiment is substantially identical to the first embodiment By way of example, the second embodiment features bat when a given fabrication apparatus issues an alarm, it is possible to automatically relay the alarm to one or more predetermined telephones whose numbers are previously stored in the computer 52, and accordingly an operator is able to know an occurrence of emergency at a distant place. Further, local and distant telephones are each able to request data acquisition (download) by accessing the personal computer 52 via the telephone line, in the case of which the computer responds to the request and sends the requested data to the telephone which is equipped with a display or connected to a printer.

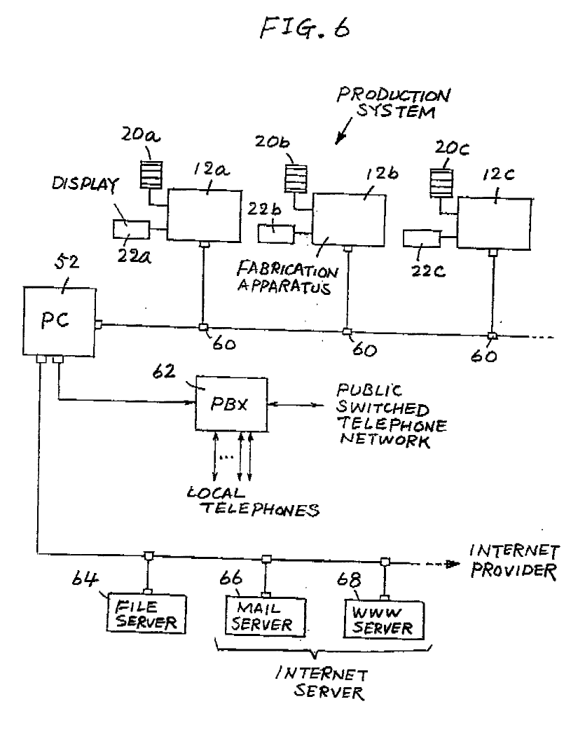

FIG. 6 is a block diagram schematically showing a third embodiment of the present invention. As illustrated, the third embodiment is provided with a file server 64, the Internet server such as a mail server 66 and a www server 68. Other than this, the third embodiment is substantially identical to the second embodiment The third embodiment features that the data, which are applied from the fabrication apparatuses 12a, 12b, and 12c and stored in the file server 62, can be accessed through the Internet. Further, the third embodiment has the advantage that when a given fabrication apparatus issues an alarm, an email is automatically sent to one or more of predetermined telephones whose numbers are previously stored in the computer 52. In this case, it is necessary to previously determine an email message corresponding to the alarm. It is to be noted that the file server 64 may be replaced with a memory installed within the personal computer 52.

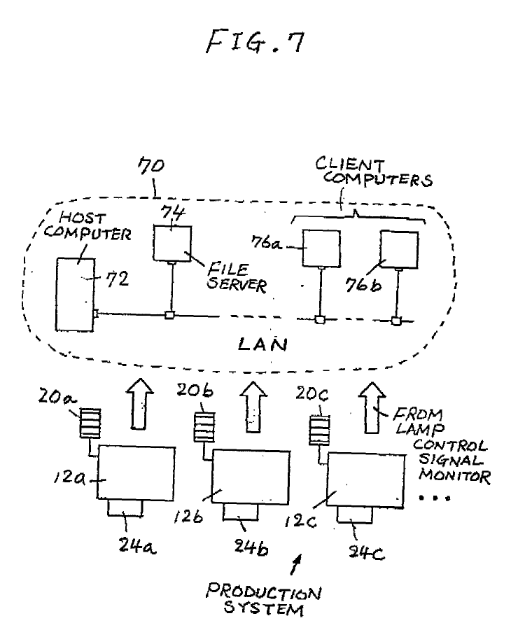

Referring to FIG. 71 a fourth embodiment of the present invention is schematically shown in block diagram form. According to the instant embodiment each of the fabrication apparatuses 12a, 12b, 12c, . . . supplies a conventional LAN (local area network) 70 with the data stored in the corresponding lamp control signal monitor (see FIG. 3). Since the LAN itself is well known in the art, the description thereof will be given in brief The LAN 70 shown in FIG. 7 comprises a host computer 72, a file server 74, and a plurality of client computers 76a, 76b, . . . Although not shown in FIG. 7, a typical LAN further comprises peripherals such as printers shared by client computers 76a, 76b, . . . The fourth embodiment features that the data, which are applied from the fabrication apparatuses 12a, 12b, and 12c and stored in a file server 62, can be shared by the client computers 76a, 76b, . . .

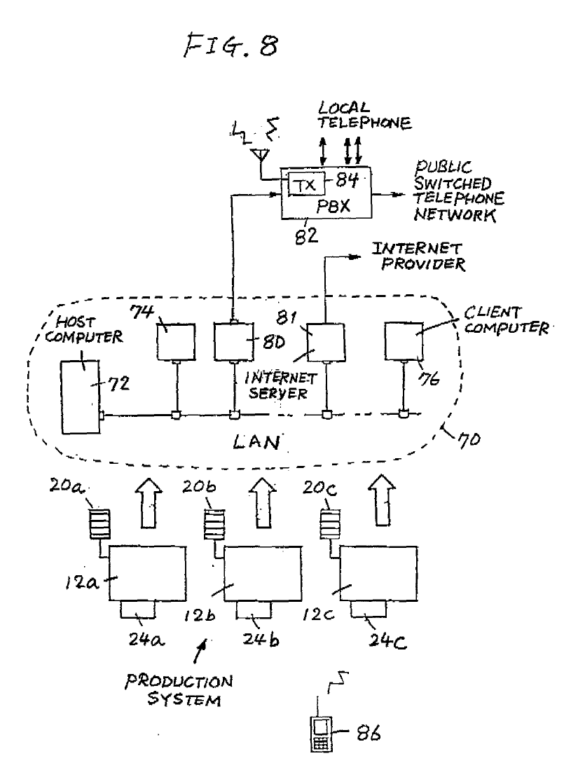

FIG. 8 is a block diagram schematically showing a fifth embodiment of the present invention. As shown, the fifth embodiment as compared with the fourth embodiment, further comprises a telecommunication server 80 and an Internet server 81 both provided in the LAN 70, a PBX 82, a transmitter (TX) 84 within the PBX 82, and one or more mobile telephones (only one is shown by reference numeral 86). The fifth embodiment features that when a given fabrication apparatus issues an alarm, it is possible to automatically relay the alarm to one or more predetermined mobile telephones whose numbers are previously stored in the host computer 72, and accordingly an operator is able to know an occurrence of emergency at a distant place. Further, the mobile telephone 86 is able to request data acquisition (download) by accessing the LAN 70 via the PBX 82, in the case of which the host computer 72 responds to the request and sends the requested data stored in the file server 74 to the mobile telephone 86 which is equipped with a display.

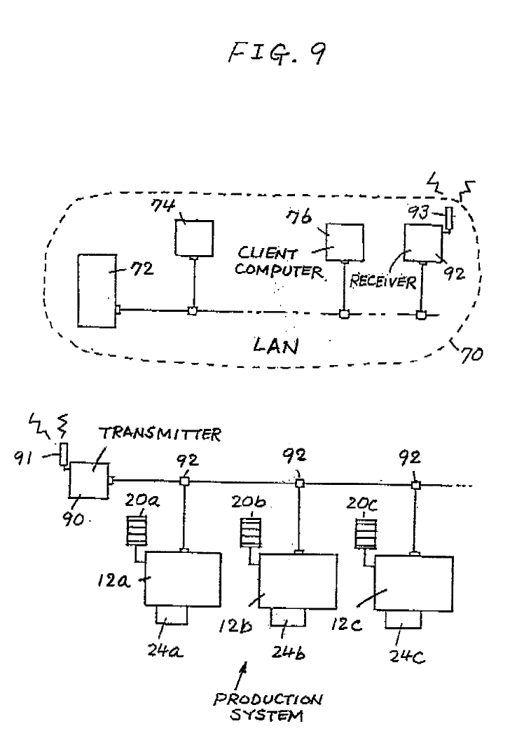

Reference is made to FIG. 9, there is shown a sixth embodiment of the present invention in block diagram form. As shown, the fabrication apparatuses 12a, 12b, 12c. . . are coupled to a transmitter 90 by way of appropriate interfaces (not shown) and connectors 92. The data issued from the lamp control signal monitor (see FIG. 3) of each of the fabrication apparatuses 12a, 12b, 12c, . . . are applied to the transmitter 90, from which the data is transmitted wirelessly to a receiver 92 provided in the LAN 70. Reference numerals 91 and 93 each denotes an antenna. The sixth embodiment is able to provide flexibility with respect to the location of the LAN 70 or the production system because they are coupled wirelessly.

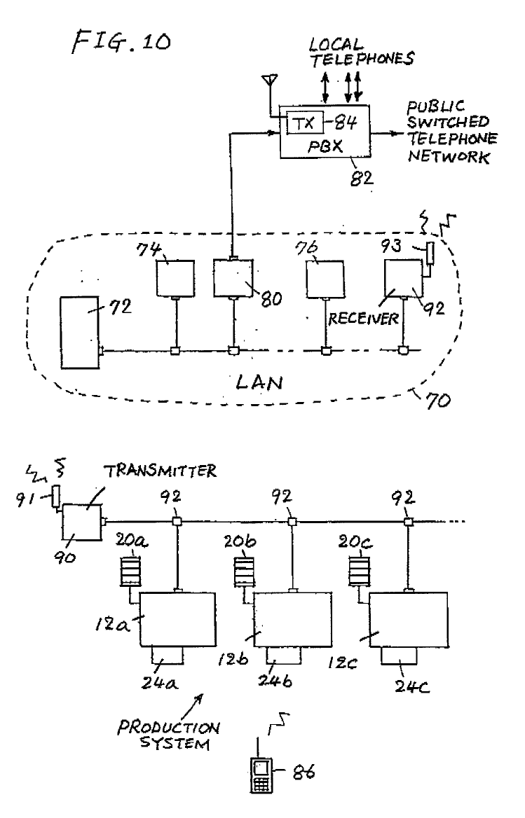

Referring to FIG. 10, a seventh embodiment is schematically shown in block diagram form. The instant embodiment is a combination of the production system of FIG. 9 and the LAN 70 of FIG. 8 with slight modification. As such, the portions identical to those in FIGS. 8 and 9 are denoted by same reference numerals. Since the operation and features of the seventh embodiment can readily be understood from the foregoing and thus further description thereof will be omitted for simplifying the disclosure.

The foregoing descriptions show seven preferred embodiments. However, other various modifications are apparent to those skilled in the art without departing from the scope of the present invention which is only limited by the appended claims. Therefore, the embodiments shown and described are only illustrated, not restrictive.

What is claimed is:

1. A production system comprising a plurality of fabrication apparatuses arranged in series for performing a sequential processing of work units applied to the system, all or some of said fabrication apparatuses being respectively equipped with light towers each of which visually indicates fabrication states of the corresponding fabrication apparatus by energizing or de-energizing different colored lamps, said production system comprises:
a lamp control signal monitor being provided in each of the light tower equipped fabrication apparatuses, said lamp control signal monitor receiving lamp control information used to energize or de-energize said colored lamps, and storing data indicative of start and finish time points and time durations of energization and de-energization of the colored lamps.

2. The production system as claimed in claim 1, wherein each of the light tower equipped fabrication apparatuses comprises a display coupled to the lamp control signal monitor, the display selectively indicating a time duration for which one of the fabrication states continues, the displaying being performed under control of said lamp control signal monitor and based on said data stored in the control signal monitor.

3. The production system as claimed in claim 2, wherein the display selectively indicate simultaneously two or more time durations for which corresponding fabrication states continue.

4. The production system as claimed in claim 2 or 3, wherein the light control signal monitor further comprises a switch for selecting one or more time durations to be displayed on the display.

5. The production system as claimed in claim 1, 2 or 3, further comprising a computer coupled to the control signal monitors of the production system so as to collect said data stored therein

6. The production system as claimed in claim 5, further comprising a private branch exchange (PBX) telephone system coupled to said computer such that a telephone coupled to the PBX is able to access said computer.

7. The production system as claimed 6, further comprising the Internet communication system coupled to the computer.

8. The production system as claimed in claim 1, wherein the lamp control signal monitors of the production system are coupled to a local area network (LAN) and respectively supply the local area network with said data indicating the start and finish time points and the time durations of energization and de-energization of the colored lamps,

9. The production system as claimed in claim 8, wherein said local area network is coupled to a PBX telephone system having a radio transmitter, whereby a wire telephone coupled to the PBX is able to access a computer provided in the LAN and whereby a mobile telephone is able to access the computer wirelessly.

10. The production system as claimed in claim 1, wherein the lamp control signal monitors of the production system are wirelessly coupled to a local area network (LAN) and respectively supply the LAN with said data indicative of the start and finish time points and the time durations of energization and de-energization of the colored lamps,

11. The production system as claimed in claim 9, wherein said local area network is coupled to a PBX telephone system having a radio transmitter, whereby a wire telephone coupled to the PBX is able to access a computer provided in the LAN and whereby a mobile telephone is able to access the computer wirelessly.
